(19) United States
(12) Patent Application Publication
(10) Pub. No.: US 2024/0071657 A1
(43) Pub. Date: Feb. 29, 2024

(54) PREPARATION PROCESS AND AUTOMATIC FILLING APPARATUS FOR CERAMIC SLURRY OF EXPLOSION-PROOF THERMISTOR

(71) Applicant: Guangdong South Hongming Electronic Science and Technology Co., Ltd., Dongguan (CN)

(72) Inventors: Shiyong Luo, Dongguan (CN); Junbin Zhao, Dongguan (CN); Zhicheng Luo, Dongguan (CN); Hengwu Liu, Dongguan (CN); Qiang He, Dongguan (CN)

(21) Appl. No.: 18/458,176

(22) Filed: Aug. 30, 2023

(30) Foreign Application Priority Data
Aug. 31, 2022 (CN) 202211051819.1

(51) Int. Cl. H01C 17/02; H01C 17/00

(52) U.S. Cl. CPC H01C 17/02; H01C 17/006

(57) ABSTRACT

Disclosed are a preparation process and an automatic filling apparatus for ceramic slurry of an explosion-proof thermistor. The automatic filling apparatus includes a slurry stirring and conveying device, a ceramic housing arranging and conveying device, a primary filling mechanism, a secondary filling mechanism, and a chip inserting mechanism, where the primary filling mechanism and the secondary filling mechanism are arranged at a left end and a right end of the ceramic housing arranging and conveying device respectively, the chip inserting mechanism is arranged between the primary filling mechanism and the secondary filling mechanism, and the slurry stirring and conveying device is connected to the primary filling mechanism and the secondary filling mechanism. The present automatic filling apparatus realizes streamlined continuous filling of the ceramic slurry of the explosion-proof thermistor. Accordingly, a filling efficiency of the explosion-proof thermistor is improved.

### CROSS-REFERENCE TO RELATED APPLICATIONS

This application claims priority of Chinese Patent Application No. 202211051819.1, filed on Aug. 31, 2022, the entire contents of which are incorporated herein by reference.

### TECHNICAL FIELD

The present disclosure relates to the technical field of thermistors, and particularly discloses a preparation process and an automatic filling apparatus for ceramic slurry of an explosion-proof thermistor.

### BACKGROUND ART

Thermistors, sensitive elements, are divided into positive temperature coefficient thermistors and negative temperature coefficient thermistors according to temperature coefficients. The thermistors are characterized by being temperature-sensitive and exhibit different resistance values at different temperatures. For the positive temperature coefficient thermistor, the higher the temperature is, the greater the resistance value becomes. For the negative temperature coefficient thermistor, the higher the temperature is, the lower the resistance value becomes. Both thermistors are semiconductor devices.

When in use, the thermistor will explode or burn under an impact of a heavy current generated in the case of excessive power, affecting safety of surrounding devices. Considering that the thermistor may explode or burn, an explosion-proof thermistor having a ceramic housing filled with ceramic slurry has been developed by our company.

For example, Utility Patent No. CN 2021229986654 provides an explosion-proof thermistor developed and disclosed by our company. The explosion-proof thermistor includes a ceramic housing and a thermistor chip arranged in the ceramic housing. The thermistor chip is provided with a pin extending out of the ceramic housing. The ceramic housing is provided with an accommodation cavity, which is used for placing the thermistor chip and provided with a downward opening only, and two opposite side walls of which are provided with locating grooves for locating the pin. Moreover, the ceramic housing is filled with filler. The utility patent effectively solves the problem that the thermistor explodes or burns under the impact of the heavy current generated in the case of the excessive power. A slurry filling process takes a significant role in a preparation process for the explosion-proof thermistor. In a conventional preparation process for an explosion-proof thermistor, an operator first arranges all ceramic housings, then squeezes prepared slurry into the ceramic housings separately through a rubber bottle, and finally inserts thermistor chips into the ceramic housings, so that the explosion-proof thermistors are prepared. The above preparation process for the explosion-proof thermistor is high in labor intensity and low in preparation efficiency. Moreover, a slurry filling amount cannot be ensured in a manual slurry filling process. Accordingly, ceramic slurry of the prepared explosion-proof thermistor has an undesirable quality. Therefore, in view of the above shortcomings in the existing preparation process for the explosion-proof thermistor, the present application provides a preparation process and an automatic filling apparatus for ceramic slurry of an explosion-proof thermistor, which can effectively solve the above technical problems.

### SUMMARY

An objective of the present disclosure is to provide a preparation process and an automatic filling apparatus for ceramic slurry of an explosion-proof thermistor, which can effectively solve the technical problems in the background art.

The present disclosure is implemented through the technical solutions as follows:

A preparation process for ceramic slurry of an explosion-proof thermistor includes:
1) weighing quartz powder, quartz sand, talcum powder, resin, and alcohol in set parts by weight respectively; and
2) putting the weighed quartz powder, quartz sand, talcum powder, resin, and alcohol into a stirring tank, and turning on a stirrer to fully stir materials for not less than 5 min, so as to obtain the ceramic slurry of the explosion-proof thermistor.

As a specific configuration of the above solution, the parts by weight of the quartz powder, the quartz sand, the talcum powder, the resin, and the alcohol are 22 parts, 35 parts, 16 parts, 12 parts, and 15 parts respectively.

As a specific configuration of the above solution, 80±5% of the quartz sand has a mesh number of 70-120, and 20±5% of the quartz sand has a mesh number of 40-70.

An automatic filling apparatus for the above ceramic slurry of the explosion-proof thermistor includes a slurry stirring and conveying device, a ceramic housing arranging and conveying device, a primary filling mechanism, a secondary filling mechanism, and a chip inserting mechanism, where the primary filling mechanism and the secondary filling mechanism are arranged at a left end and a right end of the ceramic housing arranging and conveying device respectively, the chip inserting mechanism is arranged between the primary filling mechanism and the secondary filling mechanism and arranged across a front end and a rear end of the ceramic housing arranging and conveying device, and the slurry stirring and conveying device is connected to the primary filling mechanism and the secondary filling mechanism; and
the primary filling mechanism and the secondary filling mechanism each include a gantry frame fixed to an upper end of the ceramic housing arranging and conveying device, where an upper end of the gantry frame is provided with a screw conveyor, a feeding end of the screw conveyor is connected to the slurry stirring and conveying device, a lower surface of the screw conveyor is connected to a plurality of telescopic pipes extending into the gantry frame in a spaced manner, and the telescopic pipes are provided with solenoid valves; a lower end of each telescopic pipe is connected to a slurry storage balloon, a lower end of the slurry storage balloon is connected to a filling nozzle, and a plurality of filling nozzles are jointly connected to a lifting plate; and the gantry frame is provided with a lifting driving device for realizing an up-and-down movement of the lifting plate, a strip-shaped plate is fixedly connected in a portion, positioned between the lifting plate and the slurry storage balloon, of the gantry frame, a plurality of conical extrusion hoppers are arranged on the strip-shaped plate at intervals, and the filling nozzles penetrate the corresponding conical extrusion hoppers.

As a specific configuration of the above solution, the slurry stirring and conveying device includes a stirring tank and a supporting frame, where the stirring tank is fixedly connected to an upper end of the supporting frame, and a lower end of the stirring tank is connected to a slurry outlet pipe; and an end portion of the slurry outlet pipe is connected to a slurry pump, a discharging end of the slurry pump is connected to a slurry conveying pipe, and the slurry conveying pipe is connected to the corresponding screw conveyor through a three-way pipe.

As a specific configuration of the above solution, a stirring motor is fixedly mounted at a top end of the stirring tank, an output shaft of the stirring motor is connected to a stirring frame extending into an inner cavity of the stirring tank, and a feed opening is connected to an upper end of the stirring tank.

As a specific configuration of the above solution, the ceramic housing arranging and conveying device includes a pedestal and a conveyor seat, where belt rollers are arranged at a left end and a right end of the conveyor seat respectively, and a conveyor belt is arranged between the two belt rollers; a plurality of limiting clamping strips are connected to an outer surface of the conveyor belt at equal intervals, ceramic housing locating molds are slidably inserted into the limiting clamping strips, and a row of locating insertion grooves are provided on the ceramic housing locating mold; and a mold inserting opening and a mold removing opening are provided on front side surfaces of a left end and a right end of the conveyor seat respectively.

As a further configuration of the above solution, a rear side surface of a portion, positioned between the secondary filling mechanism and the mold removing opening, of the conveyor seat is connected to a spring, and an end portion of the spring is connected to an abutment plate; an outer surface of a portion, positioned opposite the spring, of the conveyor seat is fixedly provided with a mounting plate, and a lower surface of the mounting plate is provided with a driving motor; and an upper end of an output shaft of the driving motor is connected to a rotary disc, a portion, not positioned at a circle center, of an upper surface of the rotary disc is rotatably connected to a movable rod, and an end portion of the movable rod is rotatably connected to an ejector rod moving back and forth in a limited manner.

As a specific configuration of the above solution, the chip inserting mechanism includes a frame and a mobile plate, where a strip-shaped groove is provided on a lower surface of an upper end of the frame, and a lead screw is rotatably connected in the strip-shaped groove; an upper end of the mobile plate is connected to a lead screw nut extending into the strip-shaped groove and cooperating with the lead screw; and an upper surface of the mobile plate is provided with a telescopic device, a lower end of the telescopic device is connected to a clamping jaw plate, and a lower surface of the clamping jaw plate is provided with a plurality of pairs of clamping jaw members.

As a specific configuration of the above solution, vertical strip-shaped openings are provided on inner side surfaces of two sides of the gantry frame, two ends of the lifting plate are connected to mobile blocks extending into the vertical strip-shaped openings, the lifting driving devices are arranged on two sides of an upper end of the lifting plate, and lower ends of the lifting driving devices extend into the vertical strip-shaped openings and are connected to the mobile blocks.

Beneficial Effects

When being used for preparing the explosion-proof thermistor, the ceramic slurry disclosed by the present disclosure fills a ceramic housing to fix a thermistor chip. When the thermistor explodes, the ceramic slurry can prevent filler from being sputtered out from a side surface of the housing and prevent elements beside the thermistor from being damaged. Therefore, the thermistor has an excellent explosion-proof effect.

The automatic filling apparatus disclosed by the present disclosure realizes streamlined continuous filling of the ceramic slurry of the explosion-proof thermistor. Accordingly, a filling efficiency of the explosion-proof thermistor is improved. Moreover, primary filling and secondary filling are involved. Primary filling is configured to supplement a backing material, so that the chip can be located and fixed after being inserted. Secondary filling is configured to completely cover the chip, so that an explosion-proof efficiency of an entire thermistor is ensured.

According to the filling mechanisms disclosed by the present disclosure that is differing from an existing filling mechanism, the slurry balloon enters the conical extrusion hopper to be extruded through the up-and-down movement of the lifting plate. Therefore, the ceramic slurry can be fully and rapidly extruded out, and the problem that ceramic slurry is difficult to discharge during filling by the existing filling mechanism can be avoided. Moreover, a slurry filling amount can be controlled by controlling the size of a portion, squeezed into the conical hopper, of the slurry balloon. Therefore, quantitative filling in the filling process of the explosion-proof thermistor is realized.

The present disclosure further makes improvements to the design of the apparatus. After two times of filling are completed, the driving motor is turned on when the ceramic housing locating mold is moved to be between the abutment plate and the ejector rod along with the conveyor belt. Then the ejector rod reciprocates to eject the ceramic housing locating mold to move back and forth along the limiting clamping strip under the action of the rotary disc and the movable rod. Therefore, a slurry surface fully precipitates and becomes flat and smooth, and a slurry filling effect of the explosion-proof thermistor is ensured.

### BRIEF DESCRIPTION OF THE DRAWINGS

In order to describe the technical solutions in the examples of the present disclosure more clearly, a brief description of the accompanying drawings required for describing the examples will be provided below. Obviously, the accompanying drawings in the following description show merely some examples of the present disclosure. Those of ordinary skill in the art can also derive other accompanying drawings from these accompanying drawings without creative efforts.

FIG. 1 is a stereo schematic structural diagram of an automatic filling apparatus according to the present disclosure from a first angle;

FIG. 2 is a stereo schematic structural diagram of an automatic filling apparatus according to the present disclosure from a second angle;

FIG. 3 is a stereo schematic structural diagram of a ceramic housing arranging and conveying device according to the present disclosure;

FIG. 4 is a stereo schematic structural diagram of a belt roller, a conveyor belt, and a limiting clamping strip according to the present disclosure;

FIG. 5 is a stereo schematic structural diagram of a ceramic housing locating mold according to the present disclosure;

FIG. 6 is a stereo schematic structural diagram of a filling mechanism according to the present disclosure;

FIG. 7 is a stereo schematic structural diagram of a chip inserting mechanism according to the present disclosure;

FIG. 8 is an enlarged schematic structural diagram of portion A in FIG. 3 according to the present disclosure;

FIG. 9 is an enlarged schematic structural diagram of portion B in FIG. 3 according to the present disclosure; and

FIG. 10 is a schematic planar structural diagram of an interior of a stirring tank according to the present disclosure.

In the figures:
1—slurry stirring and conveying device, 101—stirring tank, 102—supporting frame, 103—slurry outlet pipe, 104—slurry pump, 105—slurry conveying pipe, 106—stirring motor, 107—stirring frame, and 108—feed opening;
2—ceramic housing arranging and conveying device, 201—pedestal, 202—conveyor seat, 2021—mold inserting opening, 2022—mold removing opening, 203—belt roller, 204—conveyor belt, 205—limiting clamping strip, 206—ceramic housing locating mold, 2061—locating insertion groove, 207—spring, 208—abutment plate, 209—mounting plate, 210—driving motor, 211—rotary disc, 212—movable rod, and 213—ejector rod;
3—primary filling mechanism, 4—secondary filling mechanism, 301—gantry frame, 3011—vertical strip-shaped opening, 302—screw conveyor, 303—telescopic pipe, 304—solenoid valve, 305—slurry storage balloon, 306—filling nozzle, 307—lifting plate, 308—lifting driving device, 309—strip-shaped plate, and 310—conical extrusion hopper; and
5—chip inserting mechanism, 501—frame, 502—mobile plate, 503—lead screw, 504—telescopic device, 505—clamping jaw plate, and 506—clamping jaw member pair.

### DETAILED DESCRIPTION OF THE EMBODIMENTS

In order to enable those skilled in the art to better understand solutions of the present application, the technical solutions in the examples of the present application will be clearly and comprehensively described below in conjunction with the accompanying drawings in the examples of the present application. Apparently, the examples described are merely some examples rather than all examples of the present application. Based on the examples of the present application, all other examples derived by those of ordinary skill in the art without creative efforts should fall within the scope of protection of the present application.

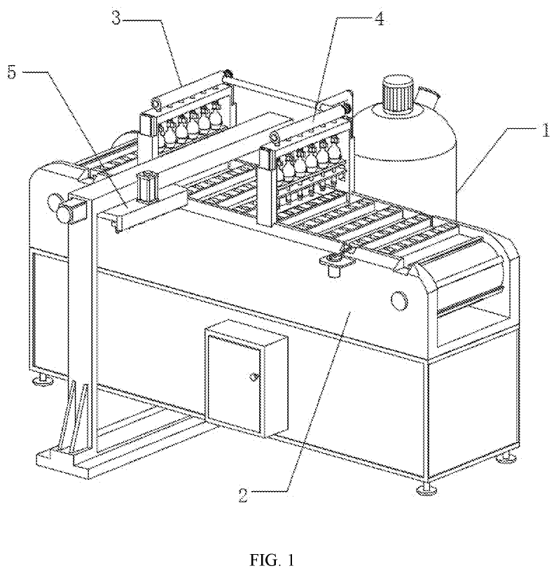

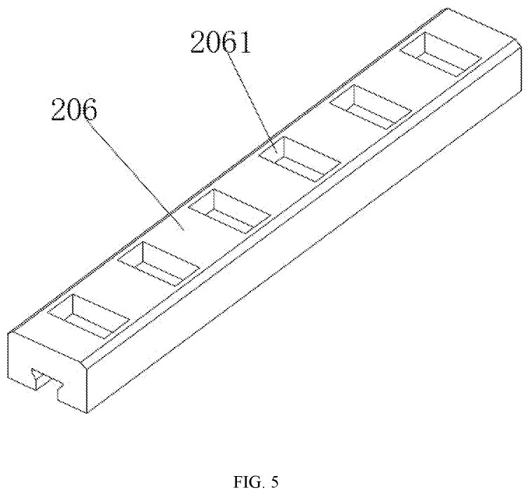

It should be noted that the examples in the present application and the features in the examples can be mutually combined without conflicts. The present application will be described in detail below in conjunction with FIGS. 1-10 and the examples.

### EXAMPLE

Ceramic slurry used in an explosion-proof thermistor is disclosed in Example 1. The ceramic slurry is prepared by stirring quartz powder, quartz sand, talcum powder, resin, and alcohol at a specific ratio.

With preparation of 10 kg of ceramic slurries of a horizontal explosion-proof thermistor as an example, 1.2 kg of resin, 1.5 kg of industrial alcohol, 2.2 kg of quartz powder, 3.5 kg of quartz sand, and 1.6 kg of talcum powder are weighed first at the specific proportion. 80% of the quartz sand has a mesh number of 70-120 and 20% of the quartz sand has a mesh number of 40-70. The amounts of rough sand and fine sand can be adjusted within a range of 5% according to climate change and different specifications.

Then the weighed quartz powder, quartz sand, talcum powder, resin, and alcohol are put into a stirring tank, and a stirrer is turned on to stir materials for at least 5 min to obtain the ceramic slurry of the explosion-proof thermistor.

When being used for preparing the explosion-proof thermistor, the ceramic slurry in Example 1 fills a ceramic housing to fix a thermistor chip. When the thermistor explodes, the ceramic slurry can prevent filler from being sputtered out from a side surface of the housing and prevent elements beside the thermistor from being damaged. Therefore, the thermistor has an excellent explosion-proof effect.

### EXAMPLE

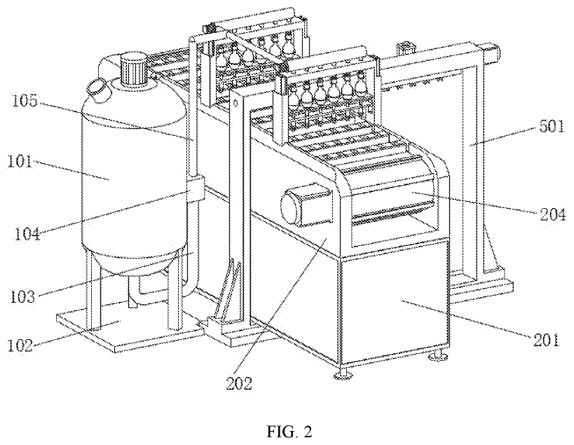

An automatic filling apparatus for the ceramic slurry of the explosion-proof thermistor in Example 1 is disclosed in Example 2. With reference to FIGS. 1 and 2, a body of the automatic filling apparatus separately includes a slurry stirring and conveying device 1, a ceramic housing arranging and conveying device 2, a primary filling mechanism 3, a secondary filling mechanism 4, and a chip inserting mechanism 5. The primary filling mechanism 3 and the secondary filling mechanism 4 are arranged at a left end and a right end of the ceramic housing arranging and conveying device 2 respectively, then, the chip inserting mechanism 5 is arranged between the primary filling mechanism 3 and the secondary filling mechanism 4, the chip inserting mechanism 5 is also arranged across a front end and a rear end of the ceramic housing arranging and conveying device 2, and the slurry stirring and conveying device 1 is connected to the primary filling mechanism 3 and the secondary filling mechanism 4.

In Example 2, ceramic housings arranged in a row are conveyed by the ceramic housing arranging and conveying device 2 at one time. When being conveyed to be right below the primary filling mechanism 3, the ceramic housings are primarily filled to supplement a backing material. Then, when the ceramic housings are conveyed to be right below the chip inserting mechanism 5, the chip of each thermistor is inserted into the corresponding ceramic housing. Finally, when being conveyed to be right below the secondary filling mechanism 4, the ceramic housings continue to be filled through the secondary filling mechanism 4 until the slurries are close to opening surfaces of upper ends of the ceramic housings, so that the chips of the thermistors are completely covered.

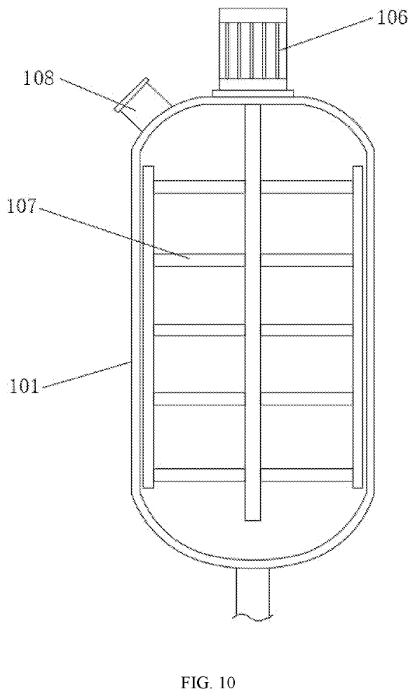

With reference to FIGS. 2 and 10, the slurry stirring and conveying device 1 includes a stirring tank 101 and a supporting frame 102, where the stirring tank 101 is fixedly connected to an upper end of the supporting frame 102, and a lower end of the stirring tank 101 is connected to a slurry outlet pipe 103; and an end portion of the slurry outlet pipe 103 is connected to a slurry pump 104, a discharging end of the slurry pump 104 is connected to a slurry conveying pipe 105, and the slurry conveying pipe 105 is connected to the corresponding screw conveyor 302 on the primary filling mechanism 3 or the secondary filling mechanism 4 through a three-way pipe.

In addition, in order to supplement the slurry in time and prevent the slurry from precipitating, in the present example, a stirring motor 106 is fixedly mounted at a top end of the stirring tank 101, an output shaft of the stirring motor 106 is connected to a stirring frame 107 extending into an inner cavity of the stirring tank 101, and a feed opening 108 is connected to an upper end of the stirring tank 101. The weighed components can be supplemented in time through the feed opening 108, and then the stirring motor 106 is turned on for stirring. Moreover, the stirring motor 106 can be continuously controlled to run in the filling process, and the slurry inside the ceramic housing is prevented from standing or precipitating under the action of the stirring frame 107.

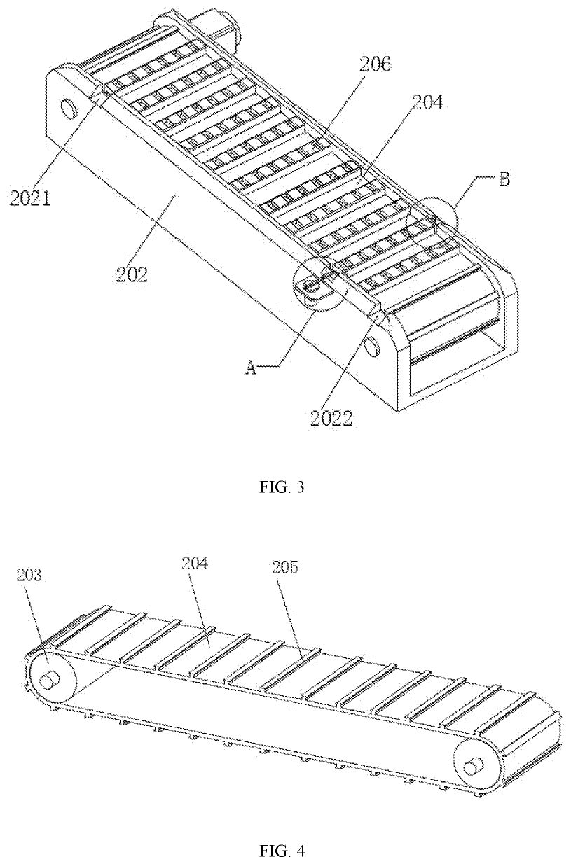

With reference to FIGS. 3, 4, and 5, the ceramic housing arranging and conveying device 2 includes a pedestal 201 and a conveyor seat 202, where belt rollers 203 are arranged at a left end and a right end of the conveyor seat 202 respectively, and a conveyor belt 204 is arranged between the two belt rollers 203; and a plurality of limiting clamping strips 205 are connected to an outer surface of the conveyor belt 204 at equal intervals. Ceramic housing locating molds 206 are slidably inserted into the limiting clamping strips 205, and a row of locating insertion grooves 2061 are provided on the ceramic housing locating mold 206; and a mold inserting opening 2021 and a mold removing opening 2022 are provided on front side surfaces of a left end and a right end of the conveyor seat 202 respectively. In a feeding process of the ceramic housings, an operator first inserts the ceramic housings into the ceramic housing locating molds 206 respectively, and then inserts the ceramic housing locating molds 206 into the limiting clamping strips 205 through the mold inserting opening 2021, so that the ceramic housings are conveyed along with the conveyor belt 204. After filling and core inserting are completed, entire ceramic housing locating molds 206 can be taken out through the mold removing opening 2022 for drying in the shade and baking, so as to be solidified.

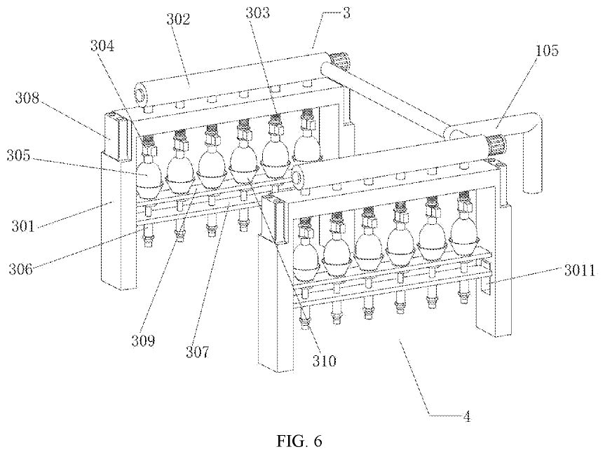

With reference to FIGS. 1 and 6, the primary filling mechanism 3 and the secondary filling mechanism 4 have the same structural design and each include a gantry frame 301 fixed to an upper end of the ceramic housing arranging and conveying device 2 and a screw conveyor 302 arranged on an upper end of the gantry frame 301. A feeding end of the screw conveyor 302 is connected to the slurry stirring and conveying device 1, a lower surface of the screw conveyor 302 is connected to a plurality of telescopic pipes 303 extending into the gantry frame 301 in a spaced manner, and the telescopic pipes 303 are provided with solenoid valves 304; and a lower end of each telescopic pipe 303 is connected to a slurry storage balloon 305, and a lower end of the slurry storage balloon 305 is connected to a filling nozzle 306. A plurality of filling nozzles 306 are jointly connected to a lifting plate 307, and the gantry frame 301 is provided with a lifting driving device 308 for realizing an up-and-down movement of the lifting plate 307. During specific configuration, vertical strip-shaped openings 3011 are provided on inner side surfaces of two sides of the gantry frame 301 first, and then two ends of the lifting plate 307 are connected to mobile blocks extending into the vertical strip-shaped openings 3011. The lifting driving devices 308 are arranged on two sides of an upper end of the lifting plate 307. Specifically, cylinders are preferably used as the lifting driving devices 308. Lower ends of the lifting driving devices 308 extend into the vertical strip-shaped openings 3011 and are connected to the mobile blocks. A strip-shaped plate 309 is fixedly connected in a portion, positioned between the lifting plate 307 and the slurry storage balloon 305, of the gantry frame 301, a plurality of conical extrusion hoppers 310 are arranged on the strip-shaped plate 309 at intervals, and the filling nozzles 306 penetrate the corresponding conical extrusion hoppers 310.

In the present example, the primary filling mechanism 3 and the secondary filling mechanism 4 have the same filling working principle. That is, the lifting driving devices 308 drive the lifting plate 307 to move downwards, and the slurry storage balloon 305 enters the conical extrusion hopper 310 to undergo gradual extrusion in a downward movement process of the lifting plate 307. The slurry storage balloon 305 will be shrunk under extrusion and deformation, so as to extrude out all the ceramic slurry therein. Then the ceramic slurry is discharged through the filling nozzle 306 to fall into the ceramic housing. Moreover, a filling amount can be controlled by controlling the size of a portion, squeezed into the conical extrusion hopper 310, of the slurry storage balloon 305, so that the filling amount is easily controlled and implemented.

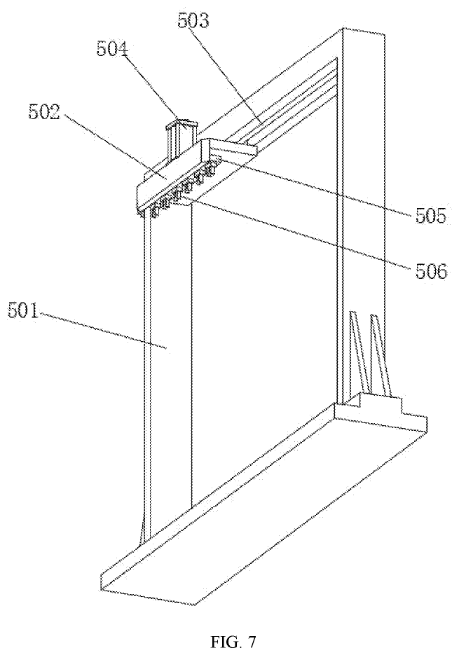

With reference to FIG. 7, the chip inserting mechanism 5 includes a frame 501 and a mobile plate 502, where a strip-shaped groove is provided on a lower surface of an upper end of the frame 501, and a lead screw 503 is rotatably connected in the strip-shaped groove; an upper end of the mobile plate 502 is connected to a lead screw nut extending into the strip-shaped groove and cooperating with the lead screw 503; and an upper surface of the mobile plate 502 is provided with a telescopic device 504, a lower end of the telescopic device 504 is connected to a clamping jaw plate 505, and a lower surface of the clamping jaw plate 505 is provided with a plurality of pairs of clamping jaw members 506. The thermistor chip is grasped by a plurality of pairs of clamping jaw members 506 at one time, and then moved to be right above the ceramic housing locating mold 206 under a driving action of the lead screw 503. Then the thermistor chip is inserted into the corresponding ceramic housing by controlling a stretching action of the telescopic device 504, and then a clamping force on the thermistor chip is released for resetting.

### EXAMPLE

An automatic filling apparatus for ceramic slurry of an explosion-proof thermistor, on which improvements to a design are made on the basis of Example 2, is disclosed in Example 3. The improvements are made to primarily solve the problem that after the slurry fills the ceramic housing, a slurry surface cannot fully precipitate or become flat and smooth.

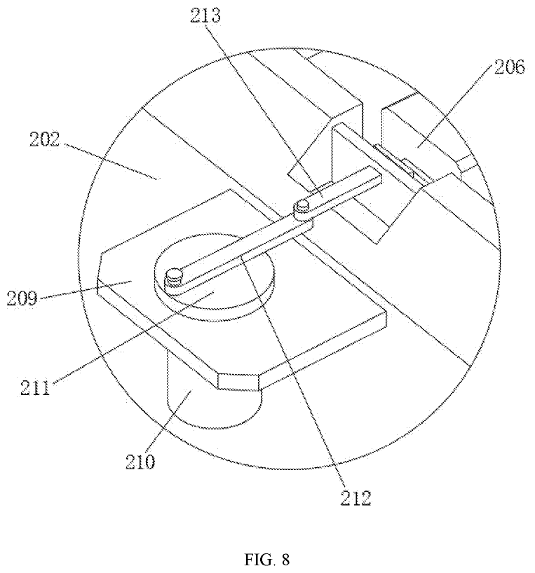

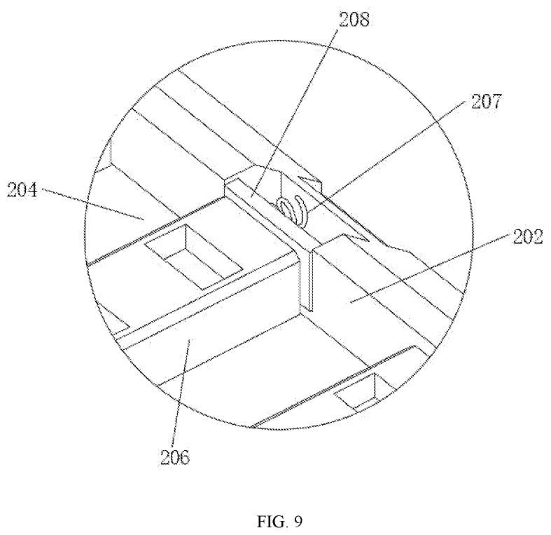

The differences between Example 3 and Example 2 are described in detail below in conjunction with FIGS. 8 and 9.

In Example 3, a rear side surface of a portion, positioned between the secondary filling mechanism 4 and the mold removing opening 2022, of the conveyor seat 202 is further connected to a spring 207, and an end portion of the spring 207 is connected to an abutment plate 208. An outer surface of a portion, positioned opposite the spring 207, of the conveyor seat 202 is fixedly provided with a mounting plate 209, and a lower surface of the mounting plate 209 is provided with a driving motor 210; and an upper end of an output shaft of the driving motor 210 is connected to a rotary disc 211, a portion, not positioned at a circle center, of an upper surface of the rotary disc 211 is rotatably connected to a movable rod 212, and an end portion of the movable rod 212 is rotatably connected to an ejector rod 213 moving back and forth in a limited manner.

Through the improvements to the design in Example 3, after two times of filling are completed, when the ceramic housing locating mold 206 is moved to be between the abutment plate 208 and the ejector rod 213 along with the conveyor belt 204, the driving motor 210 is turned on. Then the ejector rod 213 reciprocates to eject the ceramic housing locating mold 206 to move back and forth along the limiting clamping strip 205 under the action of the rotary disc 211 and the movable rod 212. Therefore, the slurry surface fully precipitates and becomes flat and smooth.

What are described above are merely preferred examples of the present disclosure, but are not intended to limit the present disclosure. Any modifications, equivalent replacements, improvements, etc. made within the spirit and principles of the present disclosure should fall within the scope of protection of the present disclosure.

1. An automatic filling apparatus for ceramic slurry of an explosion-proof thermistor, comprising a slurry stirring and conveying device (1), a ceramic housing arranging and conveying device (2), a primary filling mechanism (3), a secondary filling mechanism (4), and a chip inserting mechanism (5), wherein the primary filling mechanism (3) and the secondary filling mechanism (4) are arranged at a left end and a right end of the ceramic housing arranging and conveying device (2) respectively, the chip inserting mechanism (5) is arranged between the primary filling mechanism (3) and the secondary filling mechanism (4) and arranged across a front end and a rear end of the ceramic housing arranging and conveying device (2), and the slurry stirring and conveying device (1) is connected to the primary filling mechanism (3) and the secondary filling mechanism (4);
the primary filling mechanism (3) and the secondary filling mechanism (4) each comprise a gantry frame (301) fixed to an upper end of the ceramic housing arranging and conveying device (2), wherein an upper end of the gantry frame (301) is provided with a screw conveyor (302), a feeding end of the screw conveyor (302) is connected to the slurry stirring and conveying device (1), a lower surface of the screw conveyor (302) is connected to a plurality of telescopic pipes (303) extending into the gantry frame (301) in a spaced manner, and the telescopic pipes (303) are provided with solenoid valves (304); a lower end of each telescopic pipe (303) is connected to a slurry storage balloon (305), a lower end of the slurry storage balloon (305) is connected to a filling nozzle (306), and a plurality of filling nozzles (306) are jointly connected to a lifting plate (307); and the gantry frame (301) is provided with a lifting driving device (308) for realizing an up-and-down movement of the lifting plate (307), a strip-shaped plate (309) is fixedly connected in a portion, positioned between the lifting plate (307) and the slurry storage balloon (305), of the gantry frame (301), a plurality of conical extrusion hoppers (310) are arranged on the strip-shaped plate (309) at intervals, and the filling nozzles (306) penetrate the corresponding conical extrusion hoppers (310);
the slurry stirring and conveying device (1) comprises a stirring tank (101) and a supporting frame (102), wherein the stirring tank (101) is fixedly connected to an upper end of the supporting frame (102), and a lower end of the stirring tank (101) is connected to a slurry outlet pipe (103); and an end portion of the slurry outlet pipe (103) is connected to a slurry pump (104), a discharging end of the slurry pump (104) is connected to a slurry conveying pipe (105), and the slurry conveying pipe (105) is connected to the corresponding screw conveyor (302) through a three-way pipe; and
the automatic filling apparatus is configured for a preparation process for ceramic slurry of an explosion-proof thermistor, wherein the preparation process comprises:
weighing quartz powder, quartz sand, talcum powder, resin, and alcohol in set parts by weight respectively; and
putting the weighed quartz powder, quartz sand, talcum powder, resin, and alcohol into a stirring tank, and turning on a stirrer to fully stir materials for not less than 5 min, so as to obtain the ceramic slurry of the explosion-proof thermistor; wherein
the parts by weight of the quartz powder, the quartz sand, the talcum powder, the resin, and the alcohol are 22 parts, 35 parts, 16 parts, 12 parts, and 15 parts respectively; and
80±5% of the quartz sand has a mesh number of 70-120 and 20±5% of the quartz sand has a mesh number of 40-70.

2. The automatic filling apparatus for ceramic slurry of an explosion-proof thermistor according to claim 1, wherein a stirring motor (106) is fixedly mounted at a top end of the stirring tank (101), an output shaft of the stirring motor (106) is connected to a stirring frame (107) extending into an inner cavity of the stirring tank (101), and a feed opening (108) is connected to an upper end of the stirring tank (101).

3. The automatic filling apparatus for ceramic slurry of an explosion-proof thermistor according to claim 1, wherein the ceramic housing arranging and conveying device (2) comprises a pedestal (201) and a conveyor seat (202), belt rollers (203) are arranged at a left end and a right end of the conveyor seat (202) respectively, and a conveyor belt (204) is arranged between the two belt rollers (203); a plurality of limiting clamping strips (205) are connected to an outer surface of the conveyor belt (204) at equal intervals, ceramic housing locating molds (206) are slidably inserted into the limiting clamping strips (205), and a row of locating insertion grooves (2061) are provided on the ceramic housing locating mold (206); and a mold inserting opening (2021) and a mold removing opening (2022) are provided on front side surfaces of a left end and a right end of the conveyor seat (202) respectively.

4. The automatic filling apparatus for ceramic slurry of an explosion-proof thermistor according to claim 3, wherein a rear side surface of a portion, positioned between the secondary filling mechanism (4) and the mold removing opening (2022), of the conveyor seat (202) is connected to a spring (207), and an end portion of the spring (207) is connected to an abutment plate (208); an outer surface of a portion, positioned opposite the spring (207), of the conveyor seat (202) is fixedly provided with a mounting plate (209), and a lower surface of the mounting plate (209) is provided with a driving motor (210); and an upper end of an output shaft of the driving motor (210) is connected to a rotary disc (211), a portion, not positioned at a circle center, of an upper surface of the rotary disc (211) is rotatably connected to a movable rod (212), and an end portion of the movable rod (212) is rotatably connected to an ejector rod (213) moving back and forth in a limited manner.

5. The automatic filling apparatus for ceramic slurry of an explosion-proof thermistor according to claim 1, wherein the chip inserting mechanism (5) comprises a frame (501) and a mobile plate (502), a strip-shaped groove is provided on a lower surface of an upper end of the frame (501), and a lead screw (503) is rotatably connected in the strip-shaped groove; an upper end of the mobile plate (502) is connected to a lead screw nut extending into the strip-shaped groove and cooperating with the lead screw (503); and an upper surface of the mobile plate (502) is provided with a telescopic device (504), a lower end of the telescopic device (504) is connected to a clamping jaw plate (505), and a lower surface of the clamping jaw plate (505) is provided with a plurality of pairs of clamping jaw members (506).

6. The automatic filling apparatus for ceramic slurry of an explosion-proof thermistor according to claim 1, wherein vertical strip-shaped openings (3011) are provided on inner side surfaces of two sides of the gantry frame (301), two ends of the lifting plate (307) are connected to mobile blocks extending into the vertical strip-shaped openings (3011), the lifting driving devices (308) are arranged on two sides of an upper end of the lifting plate (307), and lower ends of the lifting driving devices (308) extend into the vertical strip-shaped openings (3011) and are connected to the mobile blocks.
